(19) United States
(12) Patent Application Publication
(10) Pub. No.: US 2026/0366527 A1
(43) Pub. Date: Nov. 19, 2026

(54) AN AXIAL-FLOW CENTRIFUGAL HYDRAULIC PUMP

(71) Applicant: SOLAR TO WATER TECHNOLOGIES PTY LTD., Beverley (AU)

(72) Inventor: Mark Jefferson KIRTLAND, Largs North (AU)

(21) Appl. No.: 19/475,683

(22) PCT Filed: Apr. 17, 2024
(86) PCT No.: PCT/AU2024/050368

§ 371 Date: Oct. 15, 2025

(30) Foreign Application Priority Data
Apr. 17, 2023 (AU) 2023901126

(51) Int. Cl. F04D 29/44; E04H 4/12; F04D 1/00; F04D 13/06; F04D 29/20

(52) U.S. Cl. CPC F04D 29/448; E04H 4/12; F04D 1/00; F04D 13/068; F04D 29/20

(57) ABSTRACT

The present invention relates to an axial-flow centrifugal hydraulic pump, particularly for recirculating water in a swimming pool or spa, comprising a Direct Current (DC) electric motor, and the pumped water passes over the DC electric motor to cool and soundproof the DC electric motor when in use.

### TECHNICAL FIELD

The present invention relates to an axial-flow centrifugal hydraulic pump, particularly for recirculating water in a swimming pool or spa. Further, but not exclusively, the pump comprises an Extra Low Voltage (ELV) Direct Current (DC) electric motor with inherent variable speed control and the pumped water passes over the DC electric motor to cool and soundproof the DC electric motor when in use.

### BACKGROUND OF INVENTION

A centrifugal hydraulic pump is a common type of pump that is used to recirculate fluid (e.g. water) in domestic and industrial applications, such as for pumping water in a swimming pool or spa. Centrifugal pumps typically consist of at least one rotating radial impeller which draws water towards its centre and, by centrifugal force, discharges water from the pump. Water enters the centre or eye of the impeller in one direction and is centrifugally flung from the impeller at a 90-degree angle to entry flow. This abrupt change in flow direction is a source of hydraulic energy loss.

In some cases, a stationary diffuser or volute is used to improve the hydraulic efficiency of a centrifugal pump. Although, for many low-cost small domestic pumps, especially pool pumps, a diffuser or volute is an additional manufacturing cost so it is not used. These lower cost pool pumps without a volute or diffuser are thus less energy efficient and typically consume more electrical energy for the same hydraulic outcome.

If a radial diffuser is used, it will typically have a number of equally spaced vanes—normally one less than the matching rotating radial impeller vanes—positioned around the outer diameter of the rotating centrifugal impeller. A volute might have one or two vanes (if self-priming) or none at all. Both the radial diffuser and the volute operate by guiding water off the impeller in a “swirling” action and directing it to the pump's discharge outlet. The diffuser or volute transforms flow of a given flow velocity and given static pressure into a flow of lower velocity and higher static pressure with little energy loss.

While radial-flow centrifugal pumps generally form the vast majority of small domestic water pumps today, another type of centrifugal pump is an axial-flow or in-line centrifugal hydraulic pump. An axial-flow centrifugal hydraulic pump incorporates a different type of impeller, such as a Francis-type or turbine impeller. Francis or turbine impellers are more commonly used in much larger industrial pumps, such as for sewerage handling. These are typically designed for higher flow rates at lower pressures (unless multi-staged) than radial-flow pumps. Due to the desired higher flow rates and lower pressures, they generally do not employ a matched diffuser to minimise energy loss.

There is therefore a need for more efficient centrifugal hydraulic pumps that minimise energy loss, especially for use in domestic applications, such as pool pumps, with rising electricity costs and efforts to minimise CO₂ emissions. Further, there is a need for quieter and potentially off-grid centrifugal hydraulic pool pumps.

The above discussion of documents, acts, materials, devices, articles and the like is included in the specification for the purpose of providing a context for the present invention. It is not suggested or represented that any or all of these matters formed part of the prior art base or were common general knowledge in the field relevant to the present invention as it existed before the priory date of each claim in this application.

### SUMMARY OF INVENTION

According to an aspect of the present invention, there is provided an axial-flow centrifugal hydraulic pump, comprising: an axially extending pump body having an inlet at one end of the pump body and an outlet at an opposed end of the pump body; a direct current (DC) electric motor housed centrally within the pump body between the inlet and the outlet and having a central rotating shaft; a turbine impeller coupled to the DC electric motor, via the rotating shaft, adjacent the inlet and configured to rotate about an axis to pump fluid from the inlet towards the outlet within the pump body, the turbine impeller having a plurality of impeller vanes; and a diffuser mounted to the pump body adjacent the outlet, the diffuser having a plurality of diffuser vanes matched to the impeller vanes to produce a laminar flow of fluid at the outlet as the pumped fluid flows through the diffuser, wherein the diffuser vanes extend axially at least partially over the DC electric motor and the pumped fluid passes over the DC electric motor to cool and soundproof the DC electric motor when in use.

Preferably, the axial-flow centrifugal hydraulic pump is used for recirculating (and filtering) water in a swimming pool. The inlet is adapted to receive water from a skimmer box of the pool and the DC electric motor is an Extra Low Voltage DC electric motor. It will be appreciated by those persons skilled in the art, however, that other fluids can be pumped by the axial-flow centrifugal hydraulic pump.

Extra Low Voltage is defined by the relevant standards and typically is in the voltage range of 24-48 V DC. The axial-flow centrifugal hydraulic pump may have a corresponding power range of 100-800 Watts.

Preferably, the Extra Low Voltage DC electric motor operates at less than 30V ripple-free DC and can be submerged safely within a swimming pool or spa.

Accordingly, for a swimming pool application, pumped water is passed over the DC electric motor to cool and soundproof the DC electric motor when in use. Further, as the axial-flow centrifugal hydraulic pump has a small footprint, and does not have an external cooling fan, it can also be installed underground, e.g. in a pit or sump adjacent the pool.

It will be appreciated, however, that the axial-flow centrifugal hydraulic pump can be used for other applications too, such as a fountain pump, spa pump, sump pump, irrigation pump, and an underwater propulsion unit or jet pack.

In an embodiment, the Extra Low Voltage DC electric motor of the axial-flow centrifugal hydraulic pump is powered by one or more photovoltaic panels and or by a battery. An axial-flow centrifugal hydraulic pump operates at higher total unit efficiency (e.g. greater than 50%) than a corresponding radial-flow centrifugal hydraulic pump with corresponding impeller diameter and input power. In addition, the matched turbine impeller and diffuser of the embodiment can deliver substantially higher flow rates (e.g. up to 70% more water flow) when compared with a corresponding radial impeller matched with a radial diffuser. Accordingly, in some applications, the axial-flow centrifugal hydraulic pump could be operated with a photovoltaic solar panel (e.g. a 390 W PV solar panel) and a battery, in an off-grid environment.

In an embodiment, the battery is a back-up to the one or more PV solar panels. For example, the battery is a 50 A/h Lithium Iron phosphate battery (LiFePO₄).

In an embodiment, the diffuser vanes and the turbine impeller vanes are equally spaced about the diffuser and the turbine impeller, respectively. The diffuser vanes are also different in number than the turbine impeller vanes. For example, the diffuser has 7 diffuser vanes equally spaced about the diffuser and the turbine has 8 turbine impeller vanes equally spaced about the turbine impeller. The matched turbine impeller and diffuser minimises energy loss associated with converting mechanical energy, via a centrifugal impeller driven by an electric motor, to hydraulic energy of the pumped fluid. The in-line design of axially aligned inlet and outlet of the axial-flow centrifugal hydraulic pump also reduces energy losses associated with directional flow change of the pumped fluid as well as minimising pressure drop when compared to a radial-flow pump.

In an embodiment, each of the turbine impeller vanes extend axially from the inlet and spirally from an eye of the impeller. Also, each of the diffuser vanes extend axially and spirally from the outlet. The shape of the diffuser vanes thus guides fluid off the impeller and provides a sweeping, gentle redirection of the fluid to create a laminar flow. The reduced turbulence of a laminar flow further reduces energy loss of the pump.

In an embodiment, the diffuser vanes are adjacent the pump body and extend radially towards the DC electric motor. As mentioned, the diffuser vanes extend at least partially over the DC electric motor so that pumped fluid passes over the DC electric motor in a laminar flow action to cool and soundproof the DC electric motor when in use. Typical centrifugal pumps, on the other hand, require a supplementary external air fan for motor cooling, which is noisy and requires additional power.

In an embodiment, the turbine impeller vanes extend radially from adjacent the rotating shaft of the DC electric motor towards the pump body. And, in an embodiment, the diameter of the turbine impeller is within a width of the diffuser vanes. That is, the axial-flow centrifugal pump, with its in-line design, is a compact design that allows for the diameter of the impeller to be close to the diameter of the pump body which improves water flow relative to the size of the pump.

In an embodiment, the rotating shaft has a conical cap adjacent the inlet configured to provide fluid to an eye of the impeller at an angle to the axis. The conical cap or cone induces less turbulence of the fluid entering the eye of the impeller. In particular, the angle to which the water enters the eye of the impeller is not 90 degrees to the exit of the impeller as per radial impellers. For example, the angle to the axis which the water enters the eye of the impeller is between 40 and 50 degrees (e.g. 40 degrees). This angle reduces the directional change of the fluid in the impeller and thus reduces energy loss. Further, the conical cap is made of metal and acts as a heat sink to transfer heat from the rotating shaft to the fluid provided to the eye of the impeller.

In an embodiment, the turbine impeller comprises a back plate at an angle to the axis and the turbine impeller vanes extend axially from the back plate. The angle of the back plate is between 1 and 89 degrees, and not 90 degrees for the above reasons. In an example, the angle of the back plate is between 40 and 50 degrees (e.g. 45 degrees).

In an embodiment, the turbine impeller is coupled to the rotating shaft of the DC electric motor via a replaceable wear ring having a peripheral wear surface.

The replaceable wear ring is forward of the impeller but not touching it.

In an embodiment, the peripheral wear surface comprises three, stepped surfaces to form a torturous path for fluid not flowing through the impeller to reduce circulation of this fluid back towards the inlet. Recirculation losses occur when fluid, under higher pressure, does not enter the discharge and instead forces its way back to the suction side. The stepped surfaces form 5 separate labyrinth-type seals against recirculation, which reduces energy loss. Moreover, the angle of the back plate of the turbine impeller, being between 40 and 50 degrees, also enables additional protection against recirculation.

According to another aspect of the present invention, there is provided an off-grid pumping system, comprising: an axial-flow centrifugal hydraulic pump as above, and one or more photovoltaic panels photovoltaic for supplying power to the Extra Low Voltage DC electric motor.

In addition, the system may further comprise a battery for receiving power from the one or more photovoltaic panels and for supplying power to the Extra Low Voltage DC electric motor.

In an embodiment, the axial-flow centrifugal hydraulic pump may be the subject of a preferred control regime of the type described in the applicant's co-pending International patent application titled “A Controller for Controlling Movement in an Aquatic Application”. The pump may also be used in a pool skimming system of the type described in the applicant's co-pending International patent application titled “Back-flushing Pool Skimming System”, both being lodged on the same day as this present application. The content of both of these co-pending patent applications is herein incorporated by reference.

### BRIEF DESCRIPTION OF DRAWINGS

Embodiments of the present invention will now be described in greater detail with reference to the accompanying drawings, in which:

FIG. 1 is a sectional view of an axial-flow centrifugal hydraulic pump according to an embodiment of the present invention;

FIG. 2 is a side view of an axial-flow centrifugal hydraulic pump according to an embodiment of the present invention;

FIG. 3 is a perspective view of a turbine impeller according to an embodiment of the present invention;

FIG. 4 is a sectional view of the turbine impeller of FIG. 3;

FIG. 5 is a sectional view of a turbine impeller within a pump body according to an embodiment of the present invention;

FIG. 6 is further section view of box E of the turbine impeller and pump body of FIG. 5;

FIG. 7 is a perspective view of a diffuser according to an embodiment of the present invention;

FIG. 8 is a perspective view of a diffuser mounted to a body of a DC electric motor according to an embodiment of the present invention;

FIG. 9 is a sectional view of an axial-flow centrifugal hydraulic pump according to an embodiment of the present invention; and

FIG. 10 is a further sectional view of the axial-flow centrifugal hydraulic pump of FIG. 9.

### DETAILED DESCRIPTION

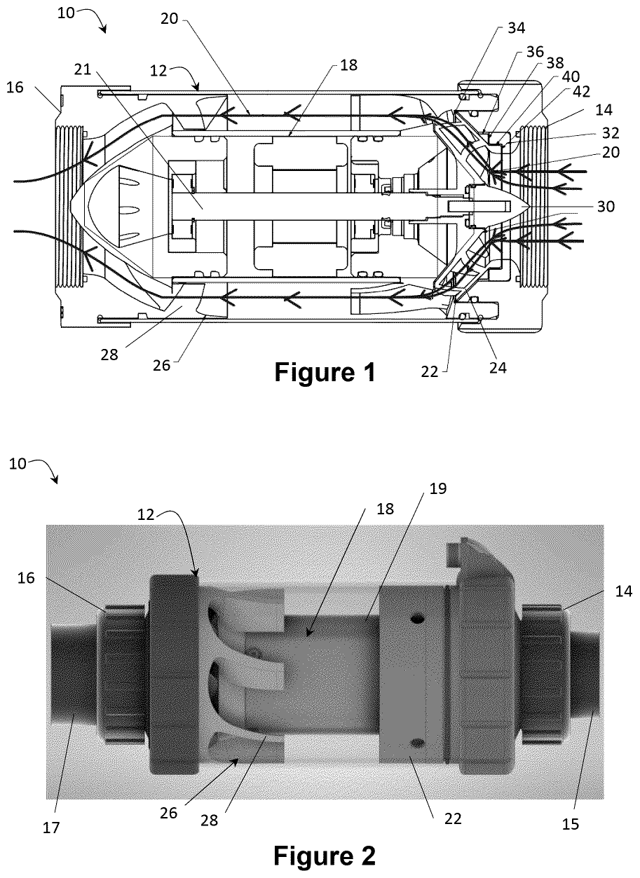

An embodiment of an in-line, axial-flow centrifugal hydraulic pump 10 is shown in FIG. 1. The pump 10 comprises an axially extending pump body 12 having an inlet 14 at one end of the pump body 12 and an outlet 16 at an opposed end of the pump body 12. The pump body 12 is cylindrical in shape and houses a cylindrically shaped direct current (DC) electric motor 18 centrally within the pump body 12 between the inlet 14 and the outlet 16 of the pump 10. The DC electric motor may be a brushless DC electric motor (BLDC).

In an embodiment, the pump 10 is used for recirculating and filtering water in a swimming pool or spa. For example, the inlet 14 is adapted to receive water from a skimmer box of the pool via a pipe 15 that is shown in FIG. 2 and is connected via a threaded and removable half union at the inlet 14. The outlet 16 is adapted to discharge water to a discharge port in the pool via a pipe 17 that is also shown in FIG. 2 and is connected via a threaded and removable half union at the outlet 16. The direction of water flow through the pump 10 is shown via the arrow 20 in FIG. 1.

As mentioned, the DC electric motor 18 is preferable an Extra Low Voltage (ELV) DC electric motor. In particular, the ELV DC electric motor 18 operates at typically less than 30V ripple-free DC so that the motor 18 can be submerged safely within water from the swimming pool and within the pump body 12 (as per AS3000 Wiring rules, zone “O” classification). The ELV motor 18 may have a power range of 100-800 Watts and it used to rotate a central rotating shaft 21 housed within a waterproof motor body 19.

Typically, an AC electric motor for an axial-flow or radial-flow centrifugal pool pump operates on 2 poles at 3000 rpm for 240V 50 Hz countries and 3600 rpm for 110V 60 Hz countries. In the embodiment, the ELV DC motor 18 operates at lower speeds of around 2000-2400 rpm, with an operational design speed range of between 1000 and 2800 rpm. These reduced pump speeds have a number of design advantages, comprising lower energy use and reduced noise.

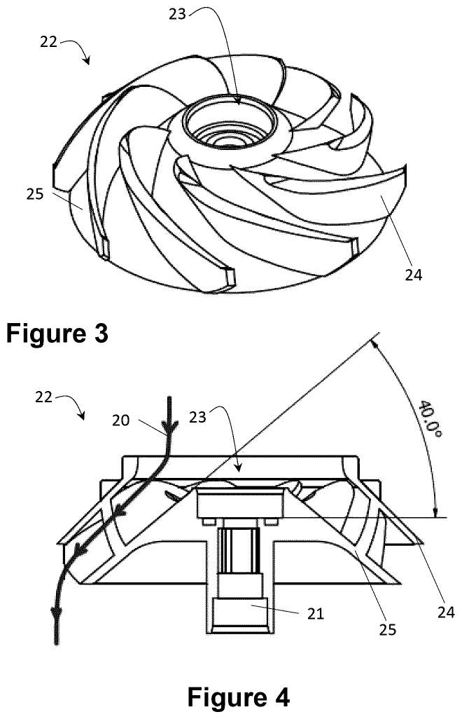

The pump 10 further comprises a turbine impeller 22 coupled to the DC electric motor 18, via the rotating shaft 21, adjacent the inlet 14. The turbine impeller 22 is configured to rotate about an axis to pump water from the inlet 14 towards the outlet 16 axially within the pump body 12. The turbine impeller 22 has a plurality of impeller vanes 24 that are equally spaced about the turbine impeller 22, as shown in FIG. 3, to pump the water.

FIG. 3 also shows that each of the turbine impeller vanes 24 extend axially from the inlet 14 and spirally from an eye 23 of the impeller 22. The turbine impeller 22 also includes a back plate 25 at an angle to the axis and the turbine impeller vanes 24 extend axially from the back plate 25. In the embodiment shown best in FIG. 4, the angle of the back plate 25 is 40 degrees. The turbine impeller vanes 24 also extend radially from adjacent the rotating shaft 21 of the DC electric motor 18, shown in FIG. 4, towards the pump body 12.

The pump 10 further includes a diffuser 26 mounted to the pump body 12 adjacent the outlet 16. The diffuser 26 a plurality of diffuser vanes 28 that are matched to the impeller vanes 24 to produce a laminar flow of water at the outlet 16 as the pumped fluid flows through the diffuser 26. The diffuser vanes 28 extend axially partially over the DC electric motor 18 and the pumped water passes over the DC electric motor 18 to cool and soundproof the DC electric motor 18 when in use.

As mentioned, the operational design speed range of the DC electric motor 18 is between 1000 and 2800 rpm, which is optimal for the turbine impeller 22 for greater flow characteristics. In an embodiment, the DC electric motor 18 is a High Efficiency Permanent Magnet DC Electric motor, and thus speed control is native DC to DC via a motor controller (not shown). Further, the pump 10 includes a DC power supply (not shown) for the DC electric motor 18. As mentioned, the DC electric motor 18 can also be powered by one or more photovoltaic panels and or by a battery (not shown). As power is not required to be inverted from AC to DC and then back to AC as a “chopped” sinewave, the motor controller generates less heat and is therefore more efficient (e.g. in the 98-99% range).

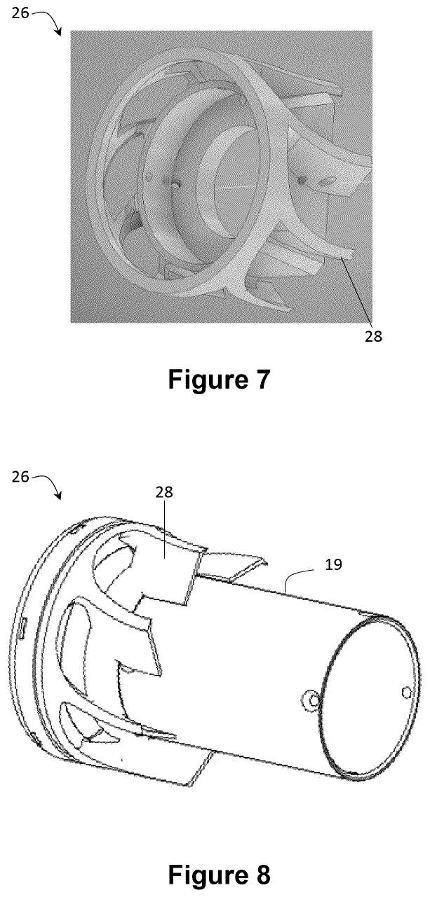

FIGS. 7 and 8 show the diffuser vanes 28 in more detail. The diffuser vanes 28 are equally spaced about the diffuser 26. The diffuser vanes 28 are different in number than the turbine impeller vanes 24 and, in the embodiment, there are 8 turbine impeller vanes 24 and 7 diffuser vanes 28. This ensures that the impeller vanes 24 can never line up exactly with the diffusor vanes 28 when rotating. Thus, avoiding the possibility of a pulse occurring while the pump 10 is operating which can lead to undesired vibration for the pump 10.

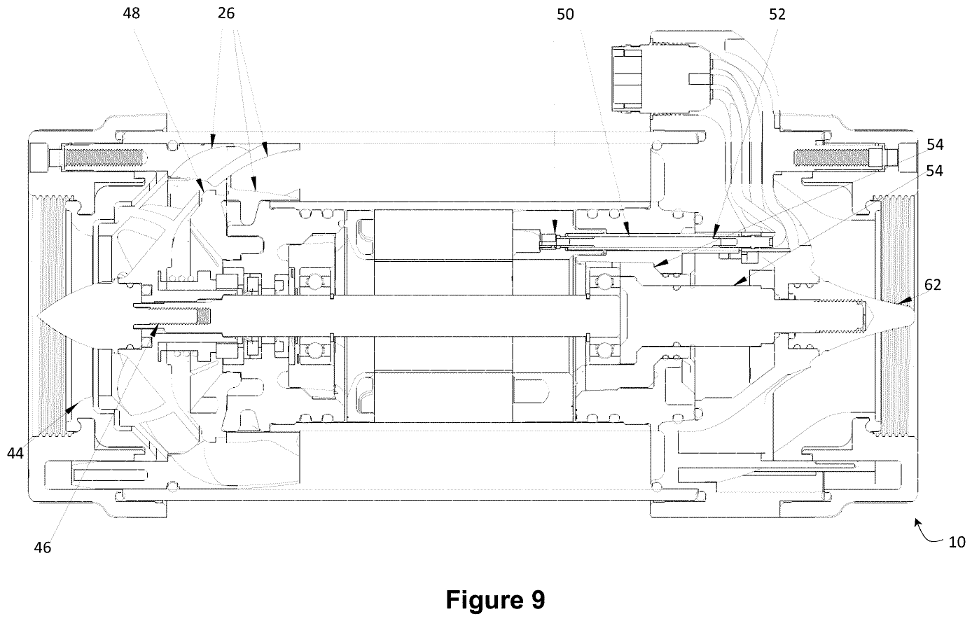

The diffuser 26 may comprise a locking mechanism for the assembly of the pump 10. The locking mechanism is shown in FIG. 9 as a locking cap 48, which works on the basis of a twisting lock. For instance, the locking mechanism may be a seven-tab locking mechanism that interacts with corresponding recesses on the electric motor body 19 so that the diffuser 26 is locked to the electric motor body 19 via twisting of the locking mechanism approximately 19 degrees. Beneficially, the locking mechanism may fix the diffuser 26 onto the electric motor body 19 in a fast and positive fitment, without the need for fixings or tools.

The diffuser locking cap 48 may be made from EDPM rubber. Once the diffuser 26 and motor end-shield of the motor body 19 are engaged, press fitment of the diffuser locking cap stops the two parts from “untwisting” once engaged. Thus, the diffuser locking cap enhances the connection between the diffuser 26 and the motor body 19.

The locking cap 48 may also have anti-air lock veins moulded into the crest of the moulding. This beneficially eliminates the possibility of “air locks” behind the turbine impeller 22 when the pump 10 is installed vertically (i.e. suction facing down).

The turbine impeller 22 is matched to the diffuser 26 to produce laminar flow and less turbulent swirl, and thus less energy loss through the pump 10. In the embodiment, the angles of the 8 turbine impeller vanes 24 are matched to the angles of the 7 diffuser vanes 28 to produce the laminar flow of water through the pump 10.

More specially, each of the diffuser vanes 28 extend axially and spirally from the outlet 16 of the pump 10. The diffuse vanes 28 thus are preferably helical shaped, such that the extending diffuse vanes 28 form part of a helix to provide laminar flow of water at the outlet 16. The diffuser vanes 28 are also adjacent the pump body 12, via a lip or seal that is not shown, and extend radially towards the body 19 of the DC electric motor 18. The lip or seal helps to reduce recirculation of water in the pump. The diameter of the turbine impeller 22 is thus within a width of the diffuser vanes 28 for maximised throughput of water through the pump 10. That is, a larger impeller diameter can be used in the pump 10 relative to the diameter of the pump body than can be employed with radial impellers which must be positioned outside the diameter of the impeller.

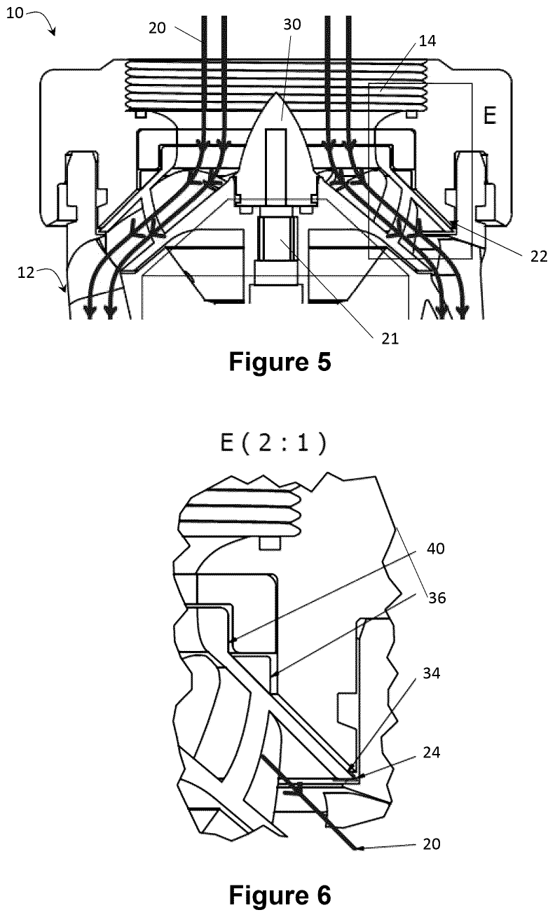

In addition, the rotating shaft 21 has a conical cap 30 (or cone) adjacent the inlet 14 that is configured to provide water to the eye 23 of the impeller 22 at an angle to the axis. As best shown in FIG. 5, water enters the inlet 14 and passes over the conical cap 30 changing the angle it is received by the impeller 22. This angle is generally between 40 and 50 degrees, which reduces the directional change required of the water in the impeller 22 to reduce energy loss.

The conical cap 30 or cone is made of metal (e.g. ZF Bronze of Stainless Steel (e.g. 316 Stainless Steel)) and also acts as a cooling device for the rotor of the DC electric motor 18. That is, the conical cap 30 sinks heat from the rotating shaft, via a connector 46 shown in FIG. 9, and into the cooler water as it enters the pump. This improves efficiency of the electric motor of the pump 10. The connector 46 between the conical cap 30 and the rotating shaft may additionally be made of Aluminium to increase the heat transfer to the conical cap 30 and thus the cooling effect of the conical cap 30. In this embodiment, the connector extends substantially into the conical cap 30 to ensure greater heat transfer. Thus, the pump 10 has two motor cooling methods: 1) External-water passing over the outside of our DC motor, and 2) Internal-via the conical cap 30.

For example, water, shown as arrow 20, enters the eye 23 of the turbine impeller 22 at a 45-degree angle from which it came via the conical cap 30. It can be seen that the front and back plates of the impeller 22 are not of equal diameter, whereas all radial impellers are parallel and of equal diameter. The angled back plate 25 allows water to exit the impeller 22 in the same direction that it entered the impeller 22 to thus provide axial flow of the water 20 in the pump 10.

The diffuser vanes 28 are angle or spiralled in such a way that once the water exits the impeller 22, the vanes 28 gently redirect the flow of water over the motor 18 and out of the outlet 16 of the pump 10 in a laminar flow motion without significant turbulence.

FIGS. 1, 5 and 6 show the turbine impeller 22 being coupled to the rotating shaft 21 of the DC electric motor 18 via a replaceable wear ring 32 having a peripheral wear surface. The wear ring 32 has a double purpose. The first is to take any wear over time, such as from the presence of abrasive sand in the water. The wear ring 32 is replaceable and thus can simply be replaced if and when the tolerances between the impeller 22 and the wear ring 32 become too great which would result in a loss of performance of the pump 10. The second purpose is to operate as an anti-recirculation device.

The peripheral wear surface of the wear ring 32 includes three, stepped surfaces to form a torturous path for fluid in the pump body not in the impeller to reduce circulation of fluid back towards the inlet. The first stepped surface forms a first labyrinth seal 34, the second stepped surface forms a second labyrinth seal 36 and a third labyrinth seal 38, and the third stepped surface forms a fourth labyrinth seal 40 and a fifth labyrinth seal 42. When water from the pressure side tries to get back into the low-pressure suction side, water can recirculate inside the pump rather than being pumped out through the resistive pipework. The wear ring 32 provides a torturous path for the water to reduce recirculation and improve efficiency of the pump 10.

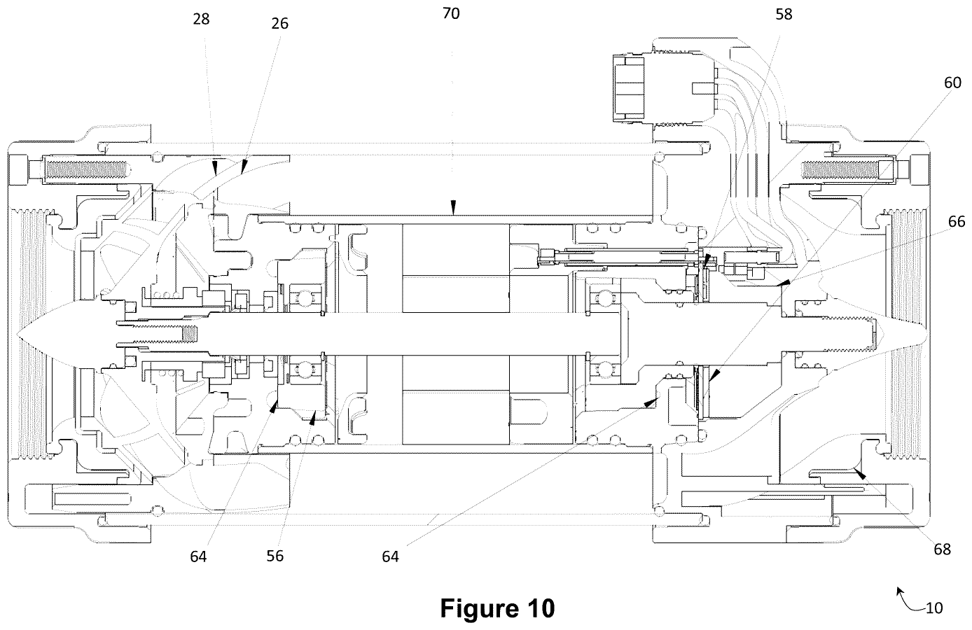

FIGS. 9 and 10 show another embodiment of the pump 10, particularly showing additional components of the 10. FIG. 9 shows a removable wear ring 44, which may be made of EDPM rubber to self-lock into the suction housing. Thus, a waterproof seal without the need for an additional O-ring or traditional thread tape may be created. The locking mechanism of the diffuser 26 may also comprise a wear ring to provide a waterproof seal without the need for an additional O-ring.

It will be appreciated by those persons skilled in the art that the motor 18 of the pump is controlled by a controller. FIG. 10 shows an embodiment where such a controller 58 is located adjacent the motor 18. In this embodiment, the electronics components associated with the controlling of the motor 18 are fitted inside the pump discharge on a PCB.

The PCB of the controller 58 is connected to the motor 18 via a three-pin connector 50 at the motor end and a short or long link connector 52 at the controller end. The short or long link connector 52 is matched to the application. The short or long link connector also comprises a three-pin connector. Beneficially, the three-pin connector 50 and the link connector 52 allows for the fast assembly of the electric motor 18 to a controller in the pump body 12. In an embodiment where the controller is not located adjacent the motor 18, a long link version of the connector 52 is used.

In the embodiment where the controller PCB 58 is located adjacent the motor 18, a short link version of the connector 52 is used to provide space for the PCB 58.

The link connectors have three pins and allow for quick and easy electrical connection of 3 phases coming out of the motor 18, and provide a fast, plug & play assembly of the motor 18 to the pump 10's centre discharge assembly. The short or long link connector 50 allows for the two major components of the pump 10's centre discharge and electric motor 18 to remain the same across all models of the pump 10, so there is no unnecessary duplication of costly components. That is, the short or long link connector 52 allows for both internal control via the controller 58 PCB or external control of the motor 18, respectively, via quick and simple fitment of the connector 52.

A thermal pad 60 may be positioned in the proximity of the PCB to transfer heat from the PCB to a heat sink 66. The heat sink may be positioned in the vicinity of the motor 18 and the PCB of the controller 58 to draw the heat from the motor 18 and the PCB into a discharge nose cone 62, shown in FIG. 9, for enhanced heat dissipation. The heat sink may be made of aluminium.

The discharge nose cone 62 may be made be made from 316 Stainless Steel. The discharge nose cone 62 acts as a central locking mechanism, clamping the entire electric motor 18 onto the pumps 10's discharge assembly. Thus, only one central nose cone, with one 22 mm Socket wrench and no other tools or bolts required for assembly. As mentioned, the discharge nose cone 62 also acts as a heat dissipation device transferring any heat generated by either the electric motor 18's non drive end bearing and, in the case of the embodiment with the PCB controller 58, any heat generated from the PCB.

In an embodiment, a two-piece discharge bearing cooler 54 may be placed near the discharge cone 62. Beneficially, this allows for quick and simple replacement of the motor bearing if required. Also, beneficially, the discharge bearing cooler acts as a heat sink drawing heat away from the electric motor 18 non-drive end bearing.

In an embodiment, a removable drive end bearing 56 is placed near the inlet. This component may be in Aluminium. This component draws any heat away from the drive end bearing. The removable drive end bearing 56 transfers the heat via cross-flow air cooling paths within the motor 18. The two-piece discharge bearing cooler also creates a cross-air flow path 64, shown in FIG. 10, between the non-drive end and the drive end bearing. This allows a more even heat dissipation within the electric motor 18, further improving the efficiency of the electric motor.

The pump may also comprise a flow director component 68. The flow director component may be positioned close to the outlet 16. The flow director component 68 may be made of EDPM rubber. The flow director component 68 may direct flow through the centre discharge into the main discharge housing. The flow director component may have substantially similar to design features to the wear ring as it self-locks/keys into the discharge housing. Thus, the flow director component may create a waterproof seal without the use of additional O-ring or thread tape. The flow director component 68 has an internal lip seal that removes the need for an additional internal O-ring.

In an embodiment, the diffuser 26 utilises 7 fin “Helix” shaped diffuser vanes 28 to more efficiency peal the water off a rotating 8 Blade impeller, resulting is less turbulence, less turbulence, improves hydraulic efficiency. This creates more of a Laminar flow, versus a turbulent flow. As mentioned, the diffuser 26 is matched to the impeller vanes 24, and this 7 fin helix-shaped diffuser 26 is matched to an 8 Blade Impeller. This ensures that at any time in the impeller's rotation, the fins do not line up exactly with the impeller blades; thus a pulse is not created.

FIG. 10 shows the (BLDC) electric motor 18 centrally located within the pump body 12, whereby the motor acts as one large and stable central “tie bolt” 70.

Typically, electric motors use at least 4 long internal tie rods/bolts to lock/hold the two motor end shields to the stator. In the embodiment, four equally spaced bolts on the peripheral of the motor 18 lock each end of the motor 18 to the pump body 12 and the complete motor assembly thus doubles a one large central tie rod, which allow the suction and discharge ends of the pump 10 to be clamped between the outer tube/casing without the need for additional internal or external tie rods/bolts. The outer tube/casing may be clear polycarbonate to allow viewing of the pump 10.

Where any or all of the terms “comprise”, “comprises”, “comprised” or “comprising” are used in this specification (including the claims), they are to be interpreted as specifying the presence of the stated features, integers, steps or components, but not precluding the presence of one or more other features, integers, steps or components.

It is to be understood that various alterations, additions and/or modification may be made to the parts previously described with departing from the ambit of the present invention.

1. An axial-flow centrifugal hydraulic pump, comprising:
an axially extending pump body having an inlet at one end of the pump body and an outlet at an opposed end of the pump body;
a direct current (DC) electric motor housed centrally within the pump body between the inlet and the outlet and having a central rotating shaft;
a turbine impeller coupled to the DC electric motor, via the rotating shaft, adjacent the inlet and configured to rotate about an axis to pump fluid from the inlet towards the outlet within the pump body, the turbine impeller having a plurality of impeller vanes; and
a diffuser mounted to the pump body adjacent the outlet, the diffuser having a plurality of diffuser vanes matched to the impeller vanes to produce a laminar flow of fluid at the outlet as the pumped fluid flows through the diffuser,
wherein the diffuser vanes extend axially at least partially over the DC electric motor and the pumped fluid passes over the DC electric motor to cool and soundproof the DC electric motor when in use.

2. An axial-flow centrifugal hydraulic pump as claimed in claim 1, wherein the diffuser vanes and the turbine impeller vanes are equally spaced about the diffuser and the turbine impeller, respectively.

3. An axial-flow centrifugal hydraulic pump as claimed in claim 2, wherein the diffuser vanes are different in number than the turbine impeller vanes.

4. An axial-flow centrifugal hydraulic pump as claimed in claim 3, wherein the diffuser has 7 diffuser vanes equally spaced about the diffuser and the turbine has 8 turbine impeller vanes equally spaced about the turbine impeller.

5. An axial-flow centrifugal hydraulic pump as claimed in claim 2, each of the turbine impeller vanes extend axially from the inlet and spirally from an eye of the impeller.

6. An axial-flow centrifugal hydraulic pump as claimed in claim 5, wherein each of the diffuser vanes extend axially and spirally from the outlet

7. An axial-flow centrifugal hydraulic pump as claimed in claim 6, wherein the diffuser vanes are adjacent the pump body and extend radially towards the DC electric motor.

8. An axial-flow centrifugal hydraulic pump as claimed in claim 7, wherein the turbine impeller vanes extend radially from adjacent the rotating shaft of the DC electric motor towards the pump body.

9. An axial-flow centrifugal hydraulic pump as claimed in claim 8, wherein the diameter of the turbine impeller is within a width of the diffuser vanes.

10. An axial-flow centrifugal hydraulic pump as claimed claim 1, wherein the rotating shaft has a conical cap adjacent the inlet configured to provide fluid to an eye of the impeller at an angle to the axis.

11. An axial-flow centrifugal hydraulic pump as claimed in claim 10, wherein the angle to the axis is between 40 and 50 degrees.

12. An axial-flow centrifugal hydraulic pump as claimed in claim 10, wherein the turbine impeller comprises a back plate at an angle to the axis and the turbine impeller vanes extend axially from the back plate.

13. An axial-flow centrifugal hydraulic pump as claimed in claim 12, wherein the angle of the back plate is between 1 and 89 degrees.

14. An axial-flow centrifugal hydraulic pump as claimed in claim 13, wherein the angle of the back plate is between 40 and 50 degrees.

15. An axial-flow centrifugal hydraulic pump as claimed in claim 10, wherein the conical cap is made of metal and acts as a heat sink to transfer heat from the rotating shaft to the fluid provided to the eye of the impeller.

16. An axial-flow centrifugal hydraulic pump as claimed in claim 1, wherein the turbine impeller is coupled to the rotating shaft of the DC electric motor via a replaceable wear ring having a peripheral wear surface.

17. An axial-flow centrifugal hydraulic pump as claimed in claim 16, wherein the peripheral wear surface comprises three, stepped surfaces to form a torturous path for fluid in the pump body not in the impeller to reduce circulation of fluid back towards the inlet.

18. An axial-flow centrifugal hydraulic pump as claimed in claim 1 for recirculating water in a swimming pool or spa, wherein the inlet is adapted to receive water from a skimmer box of the pool or spa and the DC electric motor is an Extra Low Voltage DC electric motor.

19. An axial-flow centrifugal hydraulic pump as claimed in claim 18, wherein the Extra Low Voltage DC electric motor is powered by one or more photovoltaic panels and or by a battery.

20. An off-grid pumping system, comprising: an axial-flow centrifugal hydraulic pump as claimed in claim 1, and one or more photovoltaic panels photovoltaic for supplying power to the Extra Low Voltage DC electric motor further comprising a battery for receiving power from the one or more photovoltaic panels and for supplying power to the Extra Low Voltage DC electric motor.

21. (canceled)
